(19) United States
(12) Patent Application Publication
(10) Pub. No.: US 2016/0163093 A1
(43) Pub. Date: Jun. 9, 2016

(54) METHOD AND APPARATUS FOR GENERATING IMAGE

(71) Applicant: Samsung Electronics Co., Ltd., Suwon-si (KR)

(72) Inventors: Young Ju JEONG, Yongin-si (KR); Jinho LEE, Suwon-si (KR); Yang Ho CHO, Seongnam-si (KR); Kyuhwan CHOI, Yongin-si (KR); Yoonsun CHOI, Yongin-si (KR); Dong Kyung NAM, Yongin-si (KR); Hyun Sung CHANG, Seoul (KR)

(21) Appl. No.: 14/717,504

(22) Filed: May 20, 2015

(30) Foreign Application Priority Data
Dec. 4, 2014 (KR) 10-2014-0173022

(51) Int. Cl. G06T 15/20; H04N 13/02; G06T 7/00; G06T 15/00

(52) U.S. Cl. CPC G06T 15/205; G06T 15/005; H04N 13/0271; G06T 7/0065; G06T 2207/10028; G06T 2207/10004

(57) ABSTRACT

A method includes receiving image data, and performing 3D rendering based on the image data and a depth map associated with a display.

### CROSS-REFERENCE TO RELATED APPLICATION

This application claims the priority benefit of Korean Patent Application No. 10-2014-0173022, filed on Dec. 4, 2014, in the Korean Intellectual Property Office, the entire contents of which are incorporated herein by reference in its entirety.

### BACKGROUND

1. Field

At least one example embodiment relates to a method and/or an apparatus for generating an image.

2. Description of the Related Art

A display is an apparatus for displaying an input image. Displays may be categorized as one of a flat panel display and a curved display. The flat panel display is flat and may display the input image without significant distortion. The curved display of which a display panel includes a degree of curvature may enhance the viewing experience by providing a wider viewing angle than the flat panel display. However, when a curved image is displayed on the flat panel display or when a flat image is displayed on the curved display, a user may view a distorted image.

### SUMMARY

At least one example embodiment relates to a method of generating an image.

In some example embodiments, the method may include receiving image data, and performing three-dimensional (3D) rendering, based on the image data and a depth map associated with a display.

The display may include a flat panel display, and the depth map corresponds to a curved image to be displayed on the flat panel display.

The depth map may be generated based on a curvature of the curved image.

The depth map may be generated based on a radius of curvature and a center of curvature of the curved image.

The curved image may include a plurality of differing curvatures.

The flat panel display may be at least one flat panel display among a plurality of flat panel displays.

The image data may include a two-dimensional (2D) image to be displayed on the flat panel display.

The display may include a curved display, and the depth map corresponds to a flat image to be displayed on the curved display.

When the flat image is displayed on the curved display, the depth map may be generated to offset a curvature of the curved display.

The depth map may be generated based on a radius of curvature of the curved display.

The curved display may include a plurality of differing curvature.

The curved display may be at least one curved display among a plurality of curved displays.

The image data may include a 2D image to be displayed on the curved display.

Other example embodiments relate to an apparatus for generating an image.

In some example embodiments, the apparatus may include a receiver configured to receive image data, and a processor configured to perform three-dimensional (3D) rendering, based on the image data and a depth map associated with a display.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects will become apparent and more readily appreciated from the following description of example embodiments, taken in conjunction with the accompanying drawings of which:

FIG. 1 illustrates an example of an apparatus for generating an image according to at least one example embodiment;

FIG. 2 illustrates an example of displaying a curved image on a flat panel display according to at least one example embodiment;

FIG. 3 illustrates an example of generating a depth map according to at least one example embodiment;

FIG. 4 illustrates an example of displaying a flat image on a curved display according to at least one example embodiment;

FIG. 5 illustrates an example of displaying an image having a predetermined surface on a flat panel display according to at least one example embodiment;

FIG. 6 illustrates an example of displaying a curved image on a tiled flat panel display according to at least one example embodiment;

FIG. 7 is a flowchart illustrating a method of generating an image according to at least one example embodiment; and

FIG. 8 illustrates an example of an overall operation of a method of generating an image according to at least one example embodiment.

### DETAILED DESCRIPTION OF EXAMPLE EMBODIMENTS

Hereinafter, some example embodiments will be described in detail with reference to the accompanying drawings. Regarding the reference numerals assigned to the elements in the drawings, it should be noted that the same elements will be designated by the same reference numerals, wherever possible, even though they are shown in different drawings. Also, in the description of embodiments, detailed description of well-known related structures or functions will be omitted when it is deemed that such description will cause ambiguous interpretation of the present disclosure.

It should be understood, however, that there is no intent to limit this disclosure to the particular example embodiments disclosed. On the contrary, example embodiments are to cover all modifications, equivalents, and alternatives falling within the scope of the example embodiments. Like numbers refer to like elements throughout the description of the figures.

In addition, terms such as first, second, A, B, (a), (b), and the like may be used herein to describe components. Each of these terminologies is not used to define an essence, order or sequence of a corresponding component but used merely to distinguish the corresponding component from other component(s). It should be noted that if it is described in the specification that one component is “connected”, “coupled”, or “joined” to another component, a third component may be “connected”, “coupled”, and “joined” between the first and second components, although the first component may be directly connected, coupled or joined to the second component.

The terminology used herein is for the purpose of describing particular embodiments only and is not intended to be limiting. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Various example embodiments will now be described more fully with reference to the accompanying drawings in which some example embodiments are shown. In the drawings, the thicknesses of layers and regions are exaggerated for clarity.

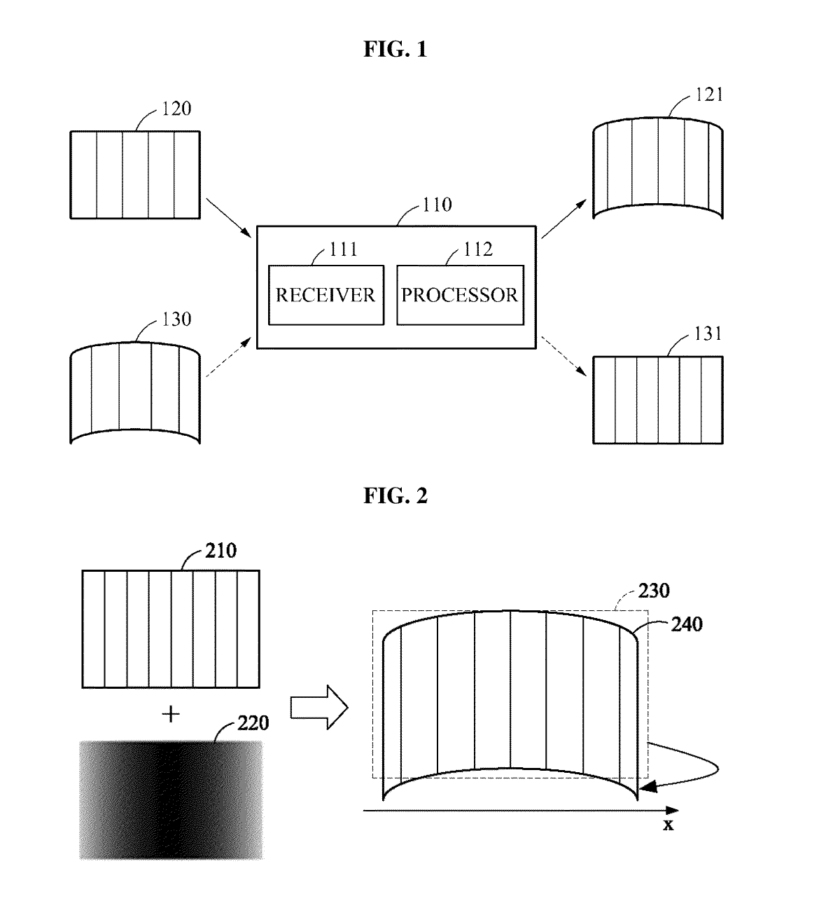

FIG. 1 illustrates an example of an apparatus for generating an image according to at least one example embodiment.

Referring to FIG. 1, an apparatus for generating an image, hereinafter referred to as an image generating apparatus 110, is an apparatus that may perform three-dimensional (3D) rendering based on image data and a depth map, and may include a receiver 111 and a processor 112. The image generating apparatus 110 may include various modules to perform 3D rendering. The various modules included in the image generating apparatus 110 may be implemented by a hardware module, a software module or a combination of the hardware module and the software module. The software module may be operated by at least one processor (i.e., a special purpose processor).

Further, the image generating apparatus 110 may include a 3D display apparatus configured to operate according to a glasses type method using an optical component, a polarizer, stereo glasses, and the like. The image generating apparatus 110 may also include a 3D display apparatus configured to operate according to a glasses-free type method using a parallax barrier, a slit back light unit (BLU), a diffuser screen, a lenticular lens, and the like.

The receiver 111 may receive image data 120 and 130. Here, the image data 120 and 130 may include a two-dimensional (2D) image. The processor 112 may perform 3D rendering based on the image data 120 and 130 and a depth map associated with a display. The depth map associated with the display may be referred to as a depth map corresponding to a form of an image to be displayed on a desired (or alternatively, predetermined) display. For example, the form of the image to be displayed may include a curved image 121, a flat image 131, an image having a desired (or alternatively, predetermined) surface, and the like.

In an example, the receiver 111 may receive the image data 120. The image data 120 may include a 2D image to be displayed on a flat panel display. The flat panel display may be a 3D display capable of displaying a result of 3D rendering.

The processor 112 may perform rendering based on a depth map corresponding to the curved image 121 to be displayed on the flat panel display and the image data 120. The result of 3D rendering may be displayed on the flat panel display. A user viewing the flat panel display may view the curved image 121 through the flat panel display.

In another example, the receiver 111 may receive the image data 130. The image data 130 may include a 2D image to be displayed on a curved display. The curved display may be a 3D display capable of displaying a result of 3D rendering.

The processor 112 may perform rendering based on a depth map corresponding to the flat image 131 to be displayed on the curved display and the image data 130. The result of 3D rendering may be displayed on the curved display. A user viewing the flat panel display may view the flat image 131 through the curved display.

FIG. 2 illustrates an example of displaying a curved image on a flat panel display according to at least one example embodiment.

Referring to FIG. 2, an image generating apparatus may receive image data 210. The image data 210 may include a 2D image to be displayed on a flat panel display 230. The image generating apparatus may generate a depth map 220 corresponding to a curved image 240 to be displayed on the flat panel display 230.

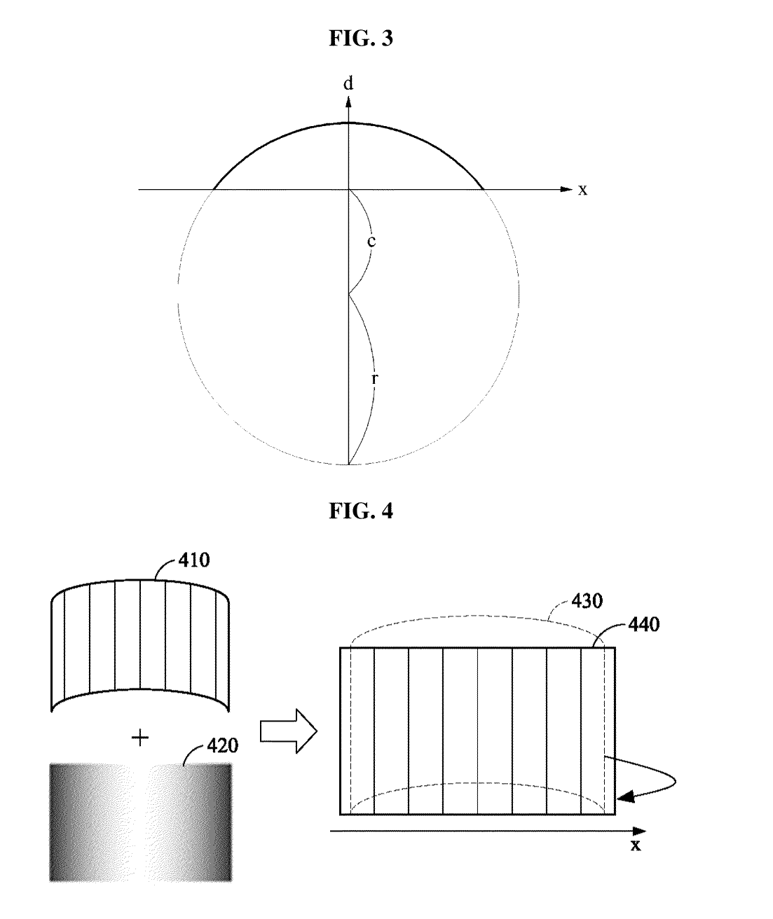

The image generating apparatus may generate the depth map 220 based on a curvature of the curved image 240. For example, when a desired (or alternatively, predetermined) pixel included in the depth map 220 illustrated in FIG. 2 has a brighter pixel value than an adjacent pixel, the desired (or alternatively, predetermined) pixel may have a higher depth value than the adjacent pixel. Conversely, when the desired (or alternatively, predetermined) pixel included in the depth map 220 illustrated in FIG. 2 has a darker pixel value than an adjacent pixel, the desired (or alternatively, predetermined) pixel may have a lower depth value than the adjacent pixel. A method of generating the depth map 220 will be described with reference to FIG. 3.

The image generating apparatus may display the curved image 240 on the flat panel display 230 by performing 3D rendering based on the generated depth map 220 and image data 210.

For example, the image generating apparatus may perform 3D rendering by weaving the multiview images and generating multiview images based on the depth map 220 and the image data 210. When the result of the 3D rendering is displayed on a 3D display using a glasses type method, the image generating apparatus may perform 3D rendering by performing rendering on a left image and a right image based on the depth map 220 and the image data 210. However, performing 3D rendering in an image generating apparatus is not limited to the aforementioned description, and thus various methods of performing 3D rendering may be applicable.

FIG. 3 illustrates an example of generating a depth map according to at least one example embodiment.

Referring to FIG. 3, a depth map generated in an image generating apparatus is illustrated. Here, an x-axis denotes a horizontal position on the flat panel display of FIG. 2, and a d-axis may denote a depth value at the horizontal position x. The depth value d included in the depth map may be calculated using Equation 1.

d=\sqrt{r²−x²}−C [Equation 1]

In Equation 1, r denotes a radius of curvature of the curved image 240 of FIG. 2, and c denotes a center of curvature of the curved image 240. The radius of curvature denotes a virtual radius of a circle defined based on a curvature, and the center of curvature may denote a virtual center of a circle defined based on the curvature of the curved image 240. The depth map generated using Equation 1 has the depth value d which varies according to the horizontal position x. However, the depth map generated using Equation 1 may have an identical depth value d with respect to the identical horizontal position x, even when a vertical position is changed.

The image generating apparatus may calculate the depth value d according to the horizontal position x of the flat panel display based on a radius of curvature r and a center of curvature c. For example, the image generating apparatus of FIG. 2 may generate the depth map 220 of FIG. 2 calculated based on the radius of curvature and the center of curvature of the curved image 240 of FIG. 2.

The image generating apparatus may change the curvature of the curved image by changing the radius of curvature r. For example, the image generating apparatus may generate a depth map corresponding to a curved image with a high degree of curvature according to an increase in the radius of curvature r. Conversely, the image generating apparatus may generate a depth map corresponding to a curved image with a low degree of curvature according to a decrease in the radius of curvature r.

FIG. 4 illustrates an example of displaying a flat image on a curved display according to at least one example embodiment.

Referring to FIG. 4, an image generating apparatus may receive image data 410. The image data 410 may include a 2D image to be displayed on a curved display 430. The image generating apparatus may generate a depth map 420 corresponding to a flat image 440 to be displayed on the curved display 430. In the depth map 420 illustrated in FIG. 4, a pixel having a brighter pixel value than an adjacent pixel may have a higher depth value than the adjacent pixel. Conversely, in the depth map 420 illustrated in FIG. 4, a pixel having a darker pixel value than an adjacent pixel may have a lower depth value than the adjacent pixel.

When the flat image 440 is displayed on the curved display 430, a curvature t of the curved display 430 may be expressed by Equation 2.

t=\sqrt{r²−x²}−C [Equation 2]

Here, r denotes a radius of curvature of the curved display 430, c denotes a center of curvature of the curved display 430, and x denotes a horizontal position in the curved display 430. The curvature t of the curved display 430 may be a desired (or alternatively, predetermined) value.

When the flat image 440 is displayed on the curved display 430, the image generating apparatus may generate the depth map 420 to offset the curvature of the curved display 430. For example, a sum of the curvature t of the curved display 430 and the depth value d of the depth map 420 may be referred to as a desired (or alternatively, predetermined) constant r-c, as expressed by Equation 3.

t+d=r−c [Equation 3]

Here, r−c may denote a virtual position of the flat image 440 to be displayed on the curved display 430. Equation 3 is directed to only the horizontal position x other than the vertical position of the curved display 430, and r-c denotes a constant. Accordingly, a result of the 3D rendering displayed on the curved display 430 may be shown as a shape of the flat image 440.

The depth value d of the depth map 420 may be expressed by Equation 4.

d=r−\sqrt{r²−x²} [Equation 4]

The image generating apparatus may calculate a depth value according to the horizontal position x of the curved display 430 based on the radius of curvature r of the curved display 430. For example, the image generating apparatus may generate the depth map 420 calculated based on the radius curvature r of the curved display 430.

The image generating apparatus may display the flat image 440 on the curved display 430 by performing 3D rendering based on the generated depth map 420 and the image data 410.

For example, the image generating apparatus may generate multiview images based on the depth map 420 and the image data 410, and perform 3D rendering by weaving the multiview images. When a result of the 3D rendering is displayed on a 3D display using a glasses type method, the image generating apparatus may perform 3D rendering by performing rendering on a left image and a right image based on the depth map 420 and the image data 410. However, performing 3D rendering in an image generating apparatus is not limited to the aforementioned description, and thus various methods of performing 3D rendering may be applicable.

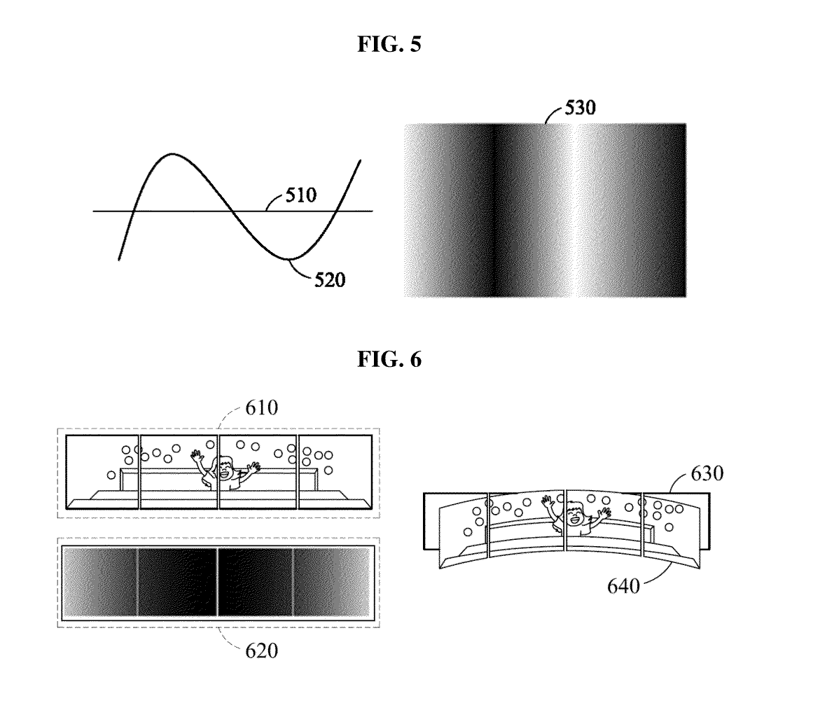

FIG. 5 illustrates an example of displaying an image having a predetermined surface on a flat panel display according to at least one example embodiment.

Referring to FIG. 5, an image generating apparatus may display an image 520 having a desired (or alternatively, predetermined) surface on a flat panel display 510. Here, the image 520 having the desired (or alternatively, predetermined) surface may be an image not limited in terms of shape. The image 520 having the desired (or alternatively, predetermined) surface may be referred to as a curved image including a plurality of differing curvatures.

An image generating apparatus may generate a depth map 530 corresponding to the image 520 having the desired (or alternatively, predetermined) surface on the flat panel display 510. Here, a depth value of the depth map 530 may be input by a user or calculated by applying the aforementioned descriptions of FIGS. 2 and 3. The image generating apparatus may display the image 520 having the desired (or alternatively, predetermined) surface on the flat panel display 510 by 3D rendering based on the depth map 530 and image data. The image data may include a 2D image displayed on the flat panel display 510.

In another example, an image generating display may display a flat image 510 on a display 520 having a desired (or alternatively, predetermined) surface. The display 520 having the desired (or alternatively, predetermined) surface is a display not limited in terms of shape. Also, the display 520 having the desired (or alternatively, predetermined) surface may be referred to as a curved display including a plurality of differing curvature.

The image generating apparatus may generate a depth map corresponding to the flat image 510 on the display 520 having the desired (or alternatively, predetermined) surface. Here, a depth value of the depth map may be input by a user or calculated by applying the aforementioned descriptions of FIG. 4. The image generating apparatus may display the flat image 510 on the display 520 having the desired (or alternatively, predetermined) surface by 3D rendering based on the depth map and image data. The image data may include a 2D image displayed on the display 520 having the desired (or alternatively, predetermined) surface.

FIG. 6 illustrates an example of displaying a curved image on a tiled flat panel display according to at least one example embodiment.

Referring to FIG. 6, an image generating apparatus may display a curved image 640 on a tiled flat panel display 630. The tiled flat panel display 630 may be referred to as a display operating similar to a flat display by combining a plurality of flat panel displays.

The image generating apparatus may receive image data 610. The image data 610 may include a 2D image displaying on the tiled flat panel display 630. The image generating apparatus may generate an entire depth map 620 corresponding to the curved image 640 to be displayed on the tiled flat panel display 630.

The image generating apparatus may generate the entire depth map 620, by generating respective depth maps corresponding to each one of flat panel displays included in the tiled flat panel display 630. For example, the image generating apparatus illustrated in FIG. 6 may divide the tiled flat panel display 630 into four detail areas and generate depth maps corresponding to the detail areas. Since the aforementioned descriptions with reference to FIGS. 2 and 3 are applicable to operation of generating a depth map corresponding to the curved image 640 to be displayed in a detail area, repeated descriptions will be omitted for conciseness.

The image generating apparatus may display the curved image 640 on the tiled flat panel display 630 by performing 3D rendering based on the image data 610 and the entire depth map 620. In another example, the image generating apparatus may perform 3D rendering for each detail area of the tiled flat panel display 630 based on a portion of the image data 610 and a portion of the entire depth map 620.

In still another example, the image generating apparatus may display a flat image on a tiled curved display. Here, the tiled curved display may be referred to as a display to operate similar to a curved display by combining a plurality of curved displays.

Similar to the tiled flat panel display, the image generating apparatus may generate an entire depth map, by generating respective depth maps corresponding to each curved display included in the tiled curved display. Since the aforementioned descriptions with reference to FIG. 4 are applicable to operation of generating a depth map corresponding to the flat image to be displayed in a detail area included in the tiled curved display, repeated descriptions will be omitted for conciseness.

The image generating apparatus may display a flat image on a tiled curved display by performing 3D rendering based on image data including a 2D image displayed on the tiled curved display and the generated entire depth map. A result of the 3D rendering, a flat image may be displayed on the tiled curved display. For example, the image generating apparatus may perform 3D rendering for each detail area of the tiled curved display based on a portion of the image data and a portion of the entire depth map.

In another example, the image generating apparatus may display an image having a desired (or alternatively, predetermined) surface on the tiled flat panel display 630. Conversely, the image generating apparatus may display a flat image on a tiled panel display having a desired (or alternatively, predetermined) surface. Since the aforementioned descriptions with reference to FIGS. 1 through 5 are applicable to the foregoing, repeated descriptions will be omitted for conciseness.

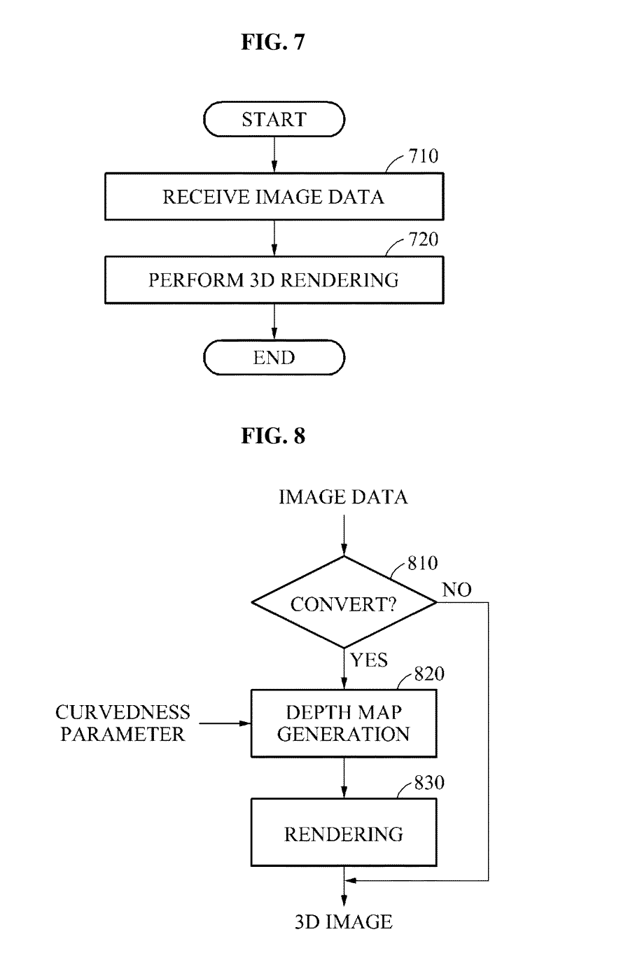

FIG. 7 is a flowchart illustrating a method of generating an image according to at least one example embodiment.

Referring to FIG. 7, the image generating apparatus 110 may receive image data in operation 710 of and perform 3D rendering based on a depth map associated with image data and a display in operation 720.

Since the aforementioned descriptions with reference to FIGS. 1 through 6 are applicable to the operations 710 and 720, repeated descriptions will be omitted for conciseness.

FIG. 8 illustrates an example of an overall operation of a method of generating an image according to at least one example embodiment.

For example, referring to FIG. 8, the image generating apparatus 110 may perform operation 810 and determine whether a 2D image included in input image data should be converted and displayed in a form of a curved image to be displayed on a flat panel display. The image generating apparatus 110 may perform operation 820 of and generate a depth map corresponding to the curved image based on a curvedness or curvature parameter of the curved image if operation 810 indicates that the curved image is to be converted and displayed. The image generating apparatus 110 may perform operation 830 and perform 3D rendering based on the image data and the depth map. If the 2D image included in the image data is determined not to be converted and displayed into the curved image in operation 810, the image generating apparatus 110 may skip operations 810-830 and perform rendering based on the input image data. Here, the curvature parameter may include at least one of a radius of curvature and a center of curvature of a curved image.

In another example, the image generating apparatus 110 may perform operation 810 and determine whether a 2D image included in input image data should be converted and displayed in a form of a flat image to be displayed on a curved display. The image generating apparatus 110 may perform operation 820 and generate a depth map corresponding to the flat image based on a curvature parameter of the curved display if the curved image is determined to be converted and displayed in operation 810. The image generating apparatus 110 may perform operation 830 and perform 3D rendering based on the image data and the depth map. If the 2D image included in the image data is determined not to be converted and displayed into the curved image in operation 810, the image generating apparatus 110 may skip operations 810-830 and perform rendering based on the input image data. Here, the curvature parameter may include at least one of a radius of curvature and a center of curvature of a curved image.

Since the aforementioned descriptions with reference to FIGS. 1 through 6 are applicable to the operations illustrated in FIG. 8, repeated descriptions will be omitted conciseness.

Example embodiments may perform 3D rendering based on a depth map corresponding to a curved image to be displayed on a flat panel display, thereby enhancing a viewing experience of a user viewing a flat panel display.

Example embodiments may perform 3D rendering based on a depth map corresponding to a flat image to be displayed on a curved display, thereby decreasing a distortion in an image caused by a geometric structure of the curved display.

Example embodiments may perform 3D rendering based on a depth map corresponding to a flat image to be displayed on a display having a desired (or alternatively, predetermined) surface, such that a shape of a display to display a flat image is not restricted.

Example embodiments may perform 3D rendering based on a depth map corresponding to a curved image to be displayed on a display having a desired (or alternatively, predetermined) surface, thereby easily displaying a large scale of curved image through a tiled flat panel display.

The units and/or modules described herein may be implemented using hardware components and software components. For example, the hardware components may include microphones, amplifiers, band-pass filters, audio to digital convertors, and processing devices. A processing device may be implemented using one or more hardware device configured to carry out and/or execute program code by performing arithmetical, logical, and input/output operations. The processing device(s) may include a processor (i.e., special purpose processor), a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such a parallel processors.

The software may include a computer program, a piece of code, an instruction, or some combination thereof, to independently or collectively instruct and/or configure the processing device to operate as desired, thereby transforming the processing device into a special purpose processor. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

A number of example embodiments have been described above. Nevertheless, it should be understood that various modifications may be made to these example embodiments. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method of generating an image, the method comprising:
receiving image data; and
performing three-dimensional (3D) rendering based on the image data and a depth map associated with a display.

2. The method of claim 1, wherein the display comprises a flat panel display, and the depth map corresponds to a curved image to be displayed on the flat panel display.

3. The method of claim 2, wherein the depth map is generated based on a curvature of the curved image.

4. The method of claim 2, wherein the depth map is generated based on a radius of curvature of the curved image and a center of curvature of the curved image.

5. The method of claim 2, wherein the curved image comprises a plurality of different curvatures.

6. The method of claim 2, wherein the flat panel display is a plurality of flat panel displays.

7. The method of claim 2, wherein the image data comprises a two-dimensional (2D) image to be displayed on the flat panel display.

8. The method of claim 1, wherein the display comprises a curved display, and the depth map corresponds to a flat image to be displayed on the curved display.

9. The method of claim 8, wherein the depth map is generated to offset a curvature of the curved display.

10. The method of claim 8, wherein the depth map is generated based on a radius of curvature of the curved display.

11. The method of claim 8, wherein the curved display comprises a plurality of different curvatures.

12. The method of claim 8, wherein the curved display is a plurality of curved displays.

13. The method of claim 8, wherein the image data comprises a 2D image to be displayed on the curved display.

14. A non-transitory computer-readable storage medium including instructions to cause a computer to perform the method of claim 1 upon the computer executing the instructions.

15. An apparatus for generating an image, the apparatus comprising:
a receiver configured to receive image data; and
a processor configured to perform three-dimensional (3D) rendering based on the image data and a depth map associated with a display.

16. The apparatus of claim 15, wherein the display comprises a flat panel display, and the depth map corresponds to a curved image to be displayed on the flat panel display.

17. The apparatus of claim 16, wherein the processor is configured to generate the depth map based on a curvature of the curved image.

18. The apparatus of claim 16, wherein the processor is configured to generate the depth map based on a radius of curvature of the curved image and a center of curvature of the curved image.

19. The apparatus of claim 15, wherein the display comprises a curved display, and the depth map corresponds to a flat image to be displayed on the curved display.

20. The apparatus of claim 19, wherein the depth map is generated based on a radius of curvature of the curved display.
